(19) United States
(12) Patent Application Publication
(10) Pub. No.: US 2007/0222387 A1
(43) Pub. Date: Sep. 27, 2007

(54) High-Pressure Discharge Lamp

(76) Inventor: Thomas Bittmann, Friedberg (DE)

Correspondence Address: OSRAM SYLVANIA INC, 100 ENDICOTT STREET, DANVERS, MA, 01923, US

(21) Appl. No.: 11/596,075

(22) PCT Filed: Apr. 29, 2005
(86) PCT No.: PCT/DE05/00792

§ 371 Date: Jan. 5, 2007

(30) Foreign Application Priority Data
May 13, 2004 (DE) 10 2004 024 063.9

(51) Int. Cl. H01J 61/04

(52) U.S. Cl. 313/631

(57) ABSTRACT

A high-pressure discharge lamp for vehicle headlights has a power consumption of less than 100 watt. The high-pressure discharge lamp includes a quartz glass discharge recipient (10) having two opposing ends (101, 102) which are sealed by molybdenum films (103, 104). Two electrodes (11, 12) which are respectively connected to one of the molybdenum films (103, 104), and an ionisable filler containing xenon and a halogenide of sodium and scandium, are arranged in the inner region (106) of the discharge recipient (10), for producing a gas discharge. The minimum distance (A) between the respective molybdenum film (103, 104) and the end of the electrode (11, 12) which is connected thereto and protrudes into the inner region (106) of the discharge recipient (10) is more than 5 mm.

The invention relates to a high-pressure discharge lamp in accordance with the precharacterizing clause of patent claim 1.

### I. PRIOR ART

Such a high-pressure discharge lamp is described, for example, in the laid-open specification EP 0 786 791 A1. This laid-open specification discloses a high-pressure discharge lamp with a base at one end for a motor vehicle headlight. The high-pressure discharge lamp has a discharge vessel, which consists of quartz glass and is sealed off at two diametrically arranged ends by means of in each case one molybdenum foil. The molybdenum foils are each connected to an electrode, which protrude into the interior of the discharge vessel. High-pressure discharge lanps for motor vehicle headlights are generally in the form of metal-halide high-pressure discharge lamps having an electrical power consumption of less than 100 watts, whose ionizable filling contains, in addition to xenon, halides of sodium and scandium.

In the abovementioned high-pressure discharge lamps, the molybdenum foils, which are embedded in the sealed ends of the discharge vessel, are subjected to a high thermal load during lamp operation, and this load may result in the molybdenum foil lifting off from the quartz glass in the discharge-side molybdenum foil region connected to the electrode and in flaws in the glass and therefore in premature failure of the lamp. This problem occurs in particular in the case of mercury-free metal-halide high-pressure discharge lamps, whose molybdenum foils are subjected to an even more severe thermal load than the molybdenum foils of the conventional mercury-containing metal-halide high-pressure discharge lamps owing to the comparatively higher lamp current and the comparatively thick electrodes.

### II. DESCRIPTION OF THE INVENTION

The object of the invention is to provide a high-pressure discharge lamp of the generic type, whose embedded molybdenum foils are subjected to a lower thermal load during lamp operation in order to achieve an extension of their life, in particular in the case of mercury-free metal-halide high-pressure discharge lamps.

This object is achieved according to the invention by the features of patent claim 1. Particularly advantageous embodiments of the invention are described in the dependent patent claims.

The high-pressure discharge lamp according to the invention for vehicle headlights having a power consumption of less than 100 watts has a discharge vessel, which consists of quartz glass and has two opposite ends which are sealed off by means of molybdenum foils, two electrodes, which are each connected to one of the molybdenum foils, and an ionizable filling, which contains xenon and halides of sodium and scandium, for producing a gas discharge being arranged in the interior of the discharge vessel, and is characterized by the fact that the smallest distance from the respective molybdenum foil to that end of the electrode connected to it which protrudes into the interior of the discharge vessel is more than 5 mm. As a result, the thermal load on the molybdenum foil region connected to the electrode is reduced to a sufficient extent in order to reduce the above-described problem. In particular in the case of mercury-free metal-halide high-pressure discharge lamps in accordance with the preferred exemplary embodiment of the invention, given a distance of 6.2 mm±0.15 mm between that edge of the molybdenum foil which faces the discharge space and that end of the electrode connected to the molybdenum foil which protrudes into the discharge space, the thermal load on the discharge-side end of the molybdenum foils could be reduced by approximately 15% and, as a result, the life of the lamps could be extended by approximately 50%.

In a particularly advantageous manner, the invention can be applied to high-pressure discharge lamps whose electrodes cause a comparatively high transfer of heat to the molybdenum foils during lamp operation owing to their dimensions, such as mercury-free metal-halide high-pressure discharge lamps whose electrodes have a comparatively great thickness or a comparatively large diameter in the range of from 0.25 mm to 0.45 mm.

In order that not too significant a proportion of the ionizable filling is lost owing to diffusion into the cavities between the electrodes and the quartz glass of the sealed ends of the discharge vessel as a result of the comparatively long electrodes of the high-pressure discharge lamps according to the invention for the gas discharge between the two electrodes in the interior of the discharge vessel and in order also to keep the risk of flaws in the quartz glass low, which flaws are caused by the thermal expansion of the electrode sections surrounded by the quartz glass of the sealed ends, the smallest distance from the molybdenum foil, in the case of mercury-free metal-halide high-pressure discharge lamps, to that end of the electrode connected to it which protrudes into the interior of the discharge vessel is preferably at most 8 mm.

### III. DESCRIPTION OF THE PREFERRED EXEMPLARY EMBODIMENT

The invention will be explained in more detail below with reference to a preferred exemplary embodiment. In the drawing:

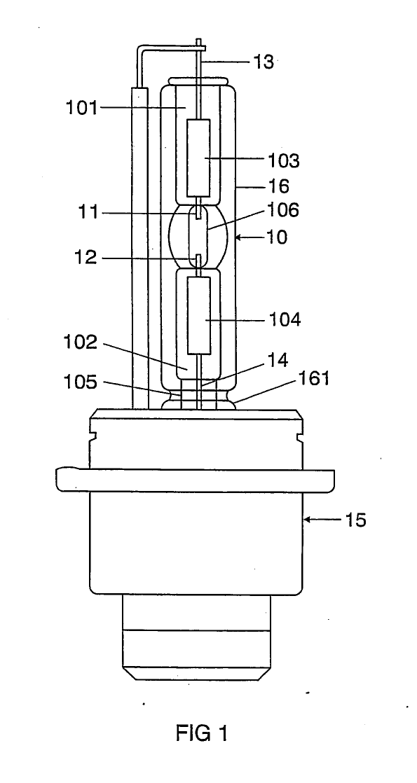

FIG. 1 shows a side view of a high-pressure discharge lamp in accordance with the preferred exemplary embodiment, in a schematic illustration, and

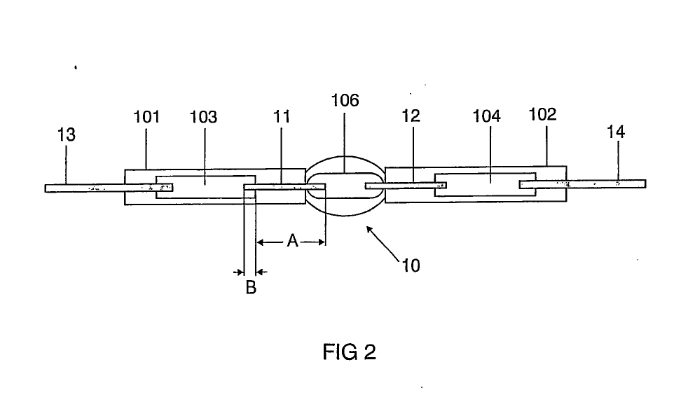

FIG. 2 shows the discharge vessel of the high-pressure discharge lamp depicted in FIG. 1, with the dimensions for the electrodes and molybdenum foils.

The preferred exemplary embodiment of the invention is a mercury-free metal-halide high-pressure discharge lamp having an electrical power consumption of approximately 35 watts. This lamp is envisaged for use in a vehicle headlight. It has a discharge vessel 30, which is sealed off at two ends, consists of quartz glass and has a volume of 24 mm³, in which an ionizable filling is enclosed in a gas-tight manner. In the region of the discharge space 106, the inner contour of the discharge vessel 30 is circular-cylindrical and its outer contour is ellipsoidal. The inner diameter of the discharge space 106 is 2.6 mm and its outer diameter is 6.3 mm. The two ends 101, 102 of the discharge vessel 10 are each sealed off by means of a molybdenum foil 103, 104 fused or pinched therein. The molybdenum foils 103, 104 each has a length of 6.5 mm, a width of 2 mm and a thickness of 25 μm. Two electrodes 11, 12, between which the discharge arc responsible for light emission is formed during lamp operation, are located in the interior of the discharge vessel 10. The electrodes 11, 12 consist of tungsten. Their thickness or their diameter is 0.30 mm. The length of the electrodes 11, 12 is in each case 7.5 mm. The distance between the electrodes 11, 12 is 4.1 mm. The electrodes 11, 12 are each electrically conductively connected to an electrical terminal of the essentially plastic lamp base 15 via one of the molybdenum foils 103, 104 and via the power supply line 13 remote from the base or via the power return line 14 on the base side. The overlap B between the electrode 11 and the molybdenum foil 103 connected to it is 1.3 mm±0.15 mm. The smallest distance A from the molybdenum foil 103 to that end of the electrode 11 which protrudes into the interior of the discharge vessel 10 is 6.2 mm±0.15 mm. This means that the distance from the molybdenum foil 11 to the discharge arc formed in the discharge vessel 10 during lamp operation is 6.2 mm±0.15 mm. Similarly, the smallest distance from the molybdenum foil 104 to that end of the electrode 12 which protrudes into the interior of the discharge vessel 10 is likewise 6.2 mm±0.15 mm since the discharge vessel 10 with the electrodes 11, 12 and the sealed-off ends 101, 102 is designed to be essentially mirror-symmetrical with respect to a mirror axis which runs through the center of the discharge vessel and is oriented at right angles with respect to the longitudinal axis of the discharge vessel 10. Given a distance of 6.2 mm between the discharge-side edge of the molybdenum foil 103 or 104 and that end of the electrode 11 or 12 which protrudes into the interior 106 of the discharge vessel 10, the maximum thermal load on the molybdenum foils 103, 104 could be restricted to less than 475° C. The discharge vessel 10 is surrounded by an outer bulb 16, which consists of quartz glass or hard glass. The quartz glass or hard glass of the outer bulb 16 is provided with the usual additives absorbing UV radiation. The outer bulb 16 has a protrusion 161 anchored in the base 15. The outer diameter of the outer bulb 16 is 9 mm and its wall thickness is 0.9 mm. The discharge vessel 10 has, on the base side, a tubular extension 105 consisting of quartz glass, in which the base-side power supply line 14 runs. The electrodes 11, 12, the molybdenum foils 103, 104 and/or power supply lines 13, 14 can be coated with ruthenium in the region of the sealed-off ends 101, 102 of the discharge vessel 10.

The ionizable filling enclosed in the discharge vessel consists of xenon having a coldfilling pressure of 11 800 hPa, 0.25 mg sodium iodide, 0.18 mg scandium iodide, 0.03 mg zinc iodide and 0.0024 mg indium iodide. The operating voltage U of the lamp is 45 volts. Its color temperature is 4000 kelvin, its color location is in the standard color table in accordance with DIN 5033 at the color coordinates x=0.383 and y=0.389. Its color rendering index is 65 and its luminous efficiency is 90 lm/W.

The invention is not restricted to the exemplary embodiment explained in more detail above, but can also be applied, for example, to mercury-containing metal-halide high-pressure discharge lamps for vehicle headlights whose electrodes have a smaller diameter of approximately 0.239 mm.

1. A high-pressure discharge lamp for vehicle headlights having a power consumption of less than 100 watts, the high-pressure discharge lamp having a discharge vessel (10), which consists of quartz glass and has two opposite ends (101, 102), which are sealed off by means of molybdenum foils (103, 104), and two electrodes (11, 12), which are each connected to one of the molybdenum foils (103, 104), and an ionizable filling, which contains xenon and halides of sodium and scandium, for producing a gas discharge being arranged in the interior (106) of the discharge vessel (10), characterized in that the smallest distance (A) from the respective molybdenum foil (103, 104) to that end of the electrode (11, 12) connected to it which protrudes into the interior (106) of the discharge vessel (10) is more than 5 mm.

2. The high-pressure discharge lamp as claimed in claim 1, characterized in that the high-pressure discharge lamp is a mercury-free metal-halide high-pressure discharge lamp.

3. The high-pressure discharge lamp as claimed in claim 1, characterized in that the smallest distance (A) from the respective molybdenum foil (103, 104) to that end of the electrode (11, 12) connected to it which protrudes into the interior (106) of the discharge vessel (10) is at least 6 mm.

4. The high-pressure discharge lamp as claimed in claim 1, characterized in that the thickness or the diameter of the electrodes (11, 12) is in the range of from 0.25 mm to 0.45 mm.

5. The high-pressure discharge lamp as claimed in claim 1, characterized in that the smallest distance (A) from the respective molybdenum foil (103, 104) to that end of the electrode (11, 12) connected to it which protrudes into the interior (106) of the discharge vessel (10) is at most 8 mm.

6. The high-pressure discharge lamp as claimed in claim 2, characterized in that the smallest distance (A) from the respective molybdenum foil (103, 104) to that end of the electrode (11, 12) connected to it which protrudes into the interior (106) of the discharge vessel (10) is at most 8 mm.

7. The high-pressure discharge lamp as claimed in claim 3, characterized in that the smallest distance (A) from the respective molybdenum foil (103, 104) to that end of the electrode (11, 12) connected to it which protrudes into the interior (106) of the discharge vessel (10) is at most 8 mm.

8. The high-pressure discharge lamp as claimed in claim 4, characterized in that the smallest distance (A) from the respective molybdenum foil (103, 104) to that end of the electrode (11, 12) connected to it which protrudes into the interior (106) of the discharge vessel (10) is at most 8 mm.

9. The high-pressure discharge lamp as claimed in claim 2, characterized in that the smallest distance (A) from the respective molybdenum foil (103, 104) to that end of the electrode (11, 12) connected to it which protrudes into the interior (106) of the discharge vessel (10) is at least 6 mm.

10. The high-pressure discharge lamp as claimed in claim 2, characterized in that the thickness or the diameter of the electrodes (11, 12) is in the range of from 0.25 mm to 0.45 mm.
